(19) United States
(12) Patent Application Publication
(10) Pub. No.: US 2013/0249297 A1
(43) Pub. Date: Sep. 26, 2013

(54) ENERGY RECOVERY FROM A PHOTOVOLTAIC ARRAY

(71) Applicants: Toru Takehara, Tokyo (JP); Shinichi Takada, Fremont, CA (US)

(72) Inventors: Toru Takehara, Tokyo (JP); Shinichi Takada, Fremont, CA (US)

(73) Assignee: PACEO CORP., Hayward, CA (US)

(21) Appl. No.: 13/741,229

(22) Filed: Jan. 14, 2013

Related U.S. Application Data
(60) Provisional application No. 61/586,036, filed on Jan. 12, 2012.

(51) Int. Cl. H02J 1/00

(52) U.S. Cl. CPC H02J 1/00
USPC 307/71

(57) ABSTRACT

An example of an apparatus includes an intelligent node having a monitoring module for controlling electrical connections to other intelligent nodes in a photovoltaic array, redundant means of communication for exchanging data and commands with other intelligent nodes, a serial-parallel selector for combining output power from a photovoltaic panel connected to the monitoring module with output power from photovoltaic panels connected to monitoring modules in other intelligent nodes, and a bypass selector for excluding power from a photovoltaic panel from the output of a photovoltaic array. An example of a method includes selecting a combination of serial and parallel electrical connections between photovoltaic panels to output a maximum amount of power from a photovoltaic array, reconfiguring the photovoltaic array into a plurality of new serial and parallel combinations, and selecting and restoring the combination having the maximum amount of output power corresponding to new operating conditions for the array.

### CROSS REFERENCE TO RELATED APPLICATIONS

This application claims the benefit of U.S. Provisional Application No. 61/586,036, filed Jan. 12, 2012 and incorporated herein by reference in its entirety.

### FIELD OF THE INVENTION

Embodiments of the invention relate generally to rapid reconfiguration of electrical connections between photovoltaic modules in a photovoltaic array, and more specifically to maximizing output power from a photovoltaic array by adaptive reconfiguration of serial and parallel electrical connections between photovoltaic modules.

### BACKGROUND

A photovoltaic (PV) module comprises many relatively small solar cells connected together in an electrical circuit. The PV module may include a transparent cover over the solar cells to protect the solar cells from mechanical damage and may be sealed to prevent circuit faults, for example open circuits or short circuits, from water or contaminants such as dust and dirt. A PV panel comprises one or more PV modules mechanically attached to a common support substrate or frame and having combined electrical outputs through one or more electrical connectors. The PV modules on one PV panel may have a fixed arrangement of electrical connections between modules. The electrical power output from one PV panel includes the power contributed from each PV module on the panel, and the output of each PV module includes the power output from each solar cell in the module.

A PV array for converting solar energy to electrical power may include several hundred PV panels mounted on the roof of a building or a mechanical support structure located close to local electrical loads. A utility-scale PV array may include thousands of PV panels electrically interconnected in large groups. A reduction in output power from a small number of PV panels in a PV array may substantially reduce output power from the entire array. For example, a reduction in output power from just one PV module on a PV panel can cause a substantial reduction in the output power from an entire PV array.

Output power from a PV panel may be reduced by, for example, a shadow falling across part of the PV panel's photosensitive surface, high temperature in part of the PV panel (sometimes referred to as a “hot spot”), aging effects, or dust, water, or debris accumulating on the PV panel. Power output may also be reduced by mechanical damage to the relatively brittle silicon material commonly used in the manufacture of commercially available PV panels. Corrosion and electrical insulation breakdown in electrical conductors, electrical connectors, and other components may also reduce PV panel output power.

Power output from a PV array may be monitored to determine if PV panels within the array have malfunctioned or are otherwise operating with reduced power output. A supervisory monitoring and control system may communicate with each of the PV panels in a PV array to log values related to PV array performance, detect fault conditions, and change operating parameters in response to load changes, weather events, daily and seasonal illumination changes, and so on. Because even a modest reduction in the output current, voltage, or power from one PV panel can reduce power output from the entire array, detection of an underperforming panel, for example a partially shadowed panel or a panel with a hot spot, may cause the supervisory control and monitoring system to switch the underperforming panel out of the array. As the shadow falls across more PV panels, for example when a cloud shadow passes over the PV array, more and more PV panels may be switched out of the PV array, and array output power decreases.

A partially-shadowed PV panel may still produce electrical output power. Even a fully shadowed PV panel may produce a usable amount of power. However, once an underperforming PV panel is switched out of a PV array, any power the PV panel could have contributed to the array output is lost. Power that might have been produced from PV panels underperforming for reasons other than partial shadowing would also be lost when the underperforming panels are switched out of an array.

A PV panel may be underperforming in the sense that its output voltage and current are less than other panels in a PV array even with all the PV panels are operating in accord with their design specifications. In this sense, underperformance is relative to other panels and may result from different operating specifications for different PV panels, for example PV panels from different manufacturers. An automatic supervisory monitoring and control system may attempt to switch such mismatched panels out of an array, even though the panels are capable of contributing power to the PV array. Some PV panels may produce more electrical power under a particular set of illumination and environmental conditions than other PV panels. It may be advantageous to be able to include different types of PV panels in one PV array to take advantage of a broader range of illumination and environmental conditions or lower-cost PV panels, without degrading the output of the array to a condition related to the lowest-performing panels.

### SUMMARY

An example of an embodiment of the invention includes a monitoring module for a photovoltaic (PV) panel. The example of a monitoring module includes a module controller, a serial-parallel selector control output electrically connected to the module controller, and a bypass selector control output electrically connected to the module controller. The example of a monitoring module further includes a first and a second of two redundant means of communication electrically connected to the module controller, and a sensor and indicator input and output module in data communication with the module controller. The example of a monitoring module also includes a power management and battery backup circuit adapted to receive input power from at least one photovoltaic panel and having an output for providing electrical power to the module controller. Some embodiments of an intelligent node do not include battery backup but may have connections for an optional external battery. Each of the at least two redundant means of communication are configured for exchanging data and commands between at least two of the module controller. The module controller selects one of the two redundant means of communication when the other of the two redundant means of communication is not available for communication. The module controller is adapted to control a series-parallel switching state of a serial-parallel selector connected to the serial-parallel selector control output. The module controller is further adapted to control a bypass switching state of a bypass switch connected to the bypass selector control output.

Another example of an embodiment of the invention comprises a method for selecting a combination of serial and parallel electrical connections between PV panels in a PV array, including connecting a plurality of PV panels in a PV array in an initial series-parallel (S-P) configuration corresponding to an initial arrangement of serial and parallel electrical connections between the PV panels, calculating an initial value of PV array output power for the initial S-P configuration, measuring an amount of output power from the PV array, and detecting a change in an amount of PV array output power in comparison to the initial value of PV array output power. The example of a method embodiment of the invention further includes reconfiguring the PV array into a plurality of new S-P combinations, and for each new S-P configuration, storing a value of PV array output power and a value representing a switching state for an S-P selector on each PV panel in the PV array, selecting the maximum value of PV array output power from the stored values of PV array output power, retrieving the value representing the switching state for an S-P selector on each PV panel in the PV array corresponding to the maximum value of PV array output power, and setting the PV array to the S-P configuration corresponding to the selected maximum value of PV array output power by setting the S-P selector on each PV panel according to the retrieved value representing the switching state.

This section summarizes some features of the present invention. These and other features, aspects, and advantages of the invention will become better understood with regard to the following description and upon reference to the following drawings.

### BRIEF DESCRIPTION OF THE DRAWINGS

FIG. 1 shows a simplified block diagram of an example of an intelligent node in accord with an embodiment of the invention in which an example of a monitoring module includes a series-parallel switch and a bypass selector.

FIG. 2 shows an example of a PV module which may be used with embodiments of the invention.

FIG. 3 shows an example of a PV panel which may be used with embodiments of the invention.

FIG. 4 continues the example of FIG. 1, showing electrical connections between parts of an intelligent node. FIG. 4 further represents an alternative embodiment of a monitoring module in which the monitoring module includes control ports for an external series-parallel switch and an external bypass selector.

FIGS. 5-7 illustrate block diagrams of alternative implementations of a module controller.

FIG. 8 illustrates an example of the intelligent node of FIGS. 1 and 4.

FIG. 9 continues the example of FIG. 4, showing components in the monitoring module for performing bypass and series-parallel (S-P) switching functions.

FIG. 10 represents an example of a reconfigurable PV array comprising two groups of interconnected intelligent nodes whose combined power outputs are connected to a DC to AC inverter.

FIGS. 11-13 show another example of a reconfigurable PV array with different configurations of serial and parallel electrical connections between intelligent nodes.

FIG. 11 shows an integer number “n” groups of intelligent nodes electrically connected in parallel, with each of the intelligent nodes within a group electrically connected in series.

FIG. 12 continues the example of FIG. 11, showing one of the groups of intelligent nodes having two intelligent nodes electrically connected in parallel and the remaining intelligent nodes in the group electrically connected in series.

FIG. 13 continues the example of FIGS. 11-12, showing more examples of different ways in which intelligent nodes within a group may be operated in selectable combinations of series and parallel electrical connections.

### DESCRIPTION

Some embodiments of the invention comprise an intelligent node for recovering energy from underperforming solar panels by adaptively switching electrical connections between intelligent nodes. Embodiments of the invention may switch electrical connections between intelligent nodes in a PV array in response to measured or predicted changes in incident solar radiation, magnitude of an electrical load receiving power from a PV array, an electrical fault in one or more PV panels in the PV array, to isolate one or more PV panels for maintenance, cleaning, or replacement, or for other reasons. A PV array in accord with an embodiment of the invention is capable of rapidly reconfiguring itself to deliver a maximum amount of output electrical power in response to measured, predicted, or reported changes in parameters that affect the operation of a PV array. Examples of parameters which may be measured or monitored by an embodiment of the invention include, but are not limited to, output current and voltage from a PV array, output voltage and current from each PV panel in a PV array, output current and voltage from PV modules on a PV panel, inverter output voltage and current, current and voltage supplied to an electrical load by the PV array, measurements of incident solar radiation, temperature measurements on a PV module, PV panel, battery, or other parts of a PV array, ground fault detectors, arc fault detectors, tilt angles for PV panels, motor voltages and currents for heliostats or systems for changing tilt angles of PV panels, and so on.

Embodiments of the invention are capable of outputting more electrical power from a partially-shadowed PV array or a PV array generating reduced output as a result of damaged or otherwise underperforming PV panels than previously known PV arrays having a fixed arrangement of serial and parallel electrical connections between PV panels. A quantitative difference in an amount of power generated by an embodiment of the invention compared to a prior-art PV array corresponds to an amount of recovered power that would have been lost in a prior-art system.

As used herein, an intelligent node refers to an apparatus for rapidly reconfiguring electrical connections between a PV panel connected to the intelligent node and PV panels connected to other intelligent nodes, without disconnecting and reconnecting electrical cables between intelligent nodes or between PV panels. A plurality of intelligent nodes electrically connected with one another is referred to as a reconfigurable PV array. Each intelligent node optionally includes at least one PV panel. Each PV panel includes at least one PV module, and each PV module includes a plurality of interconnected PV cells. More than one PV panel may optionally be connected as a group to one intelligent node, and the intelligent node may control electrical connections between its connected group of PV panels and groups of PV panels connected to other intelligent nodes.

An intelligent node in accord with an embodiment of the invention may accept commands from an external supervisory monitoring and control system to change serial and parallel electrical (S-P) connections to neighboring intelligent nodes or to bypass one or more PV panels, or the intelligent node may make such switching changes autonomously. Intelligent nodes may communicate measured values related to solar panel performance to the supervisory control and monitoring system and to other intelligent nodes. Some embodiments of the invention comprise a PV array including a plurality of interconnected intelligent nodes. Some embodiments of the invention include steps in a method for finding a combination of S-P connections between intelligent nodes in a reconfigurable PV array that result in a maximum amount of PV array output electrical power for a given set of operating conditions.

Embodiments of the invention are able to rapidly adapt to changing operating conditions such as, but not limited to, partially shadowed PV panels, weather changes, hot spots on one or more PV panels, or dirt or foreign objects obscuring light-sensitive surfaces on part of one or more PV panels. Embodiments of the invention are also able to maximize power output from PV arrays comprising PV panels having mismatched specifications for output voltage, current, and power. Such mismatches may be related to differences in design specifications between panels from different manufacturers or may be the result of differences in aging effects between one group of PV panels and another. Intelligent nodes are particularly well suited to recovering power from underperforming PV panels by connecting underperforming PV panels in an optimized combination of serial and parallel electrical connections to PV panels in other intelligent nodes, rather than simply switching underperforming PV panels out of the PV array as is commonly done in prior art arrays.

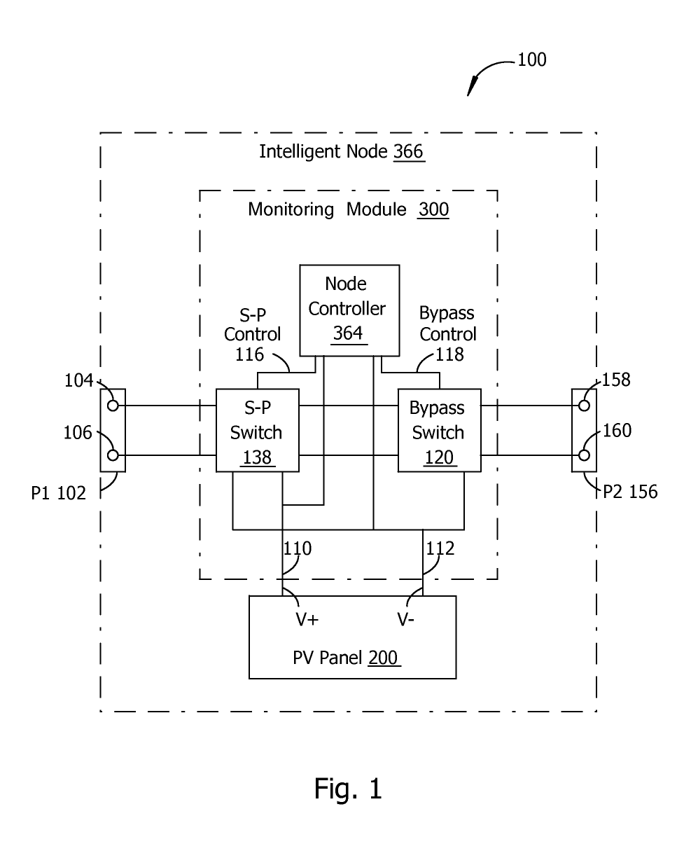

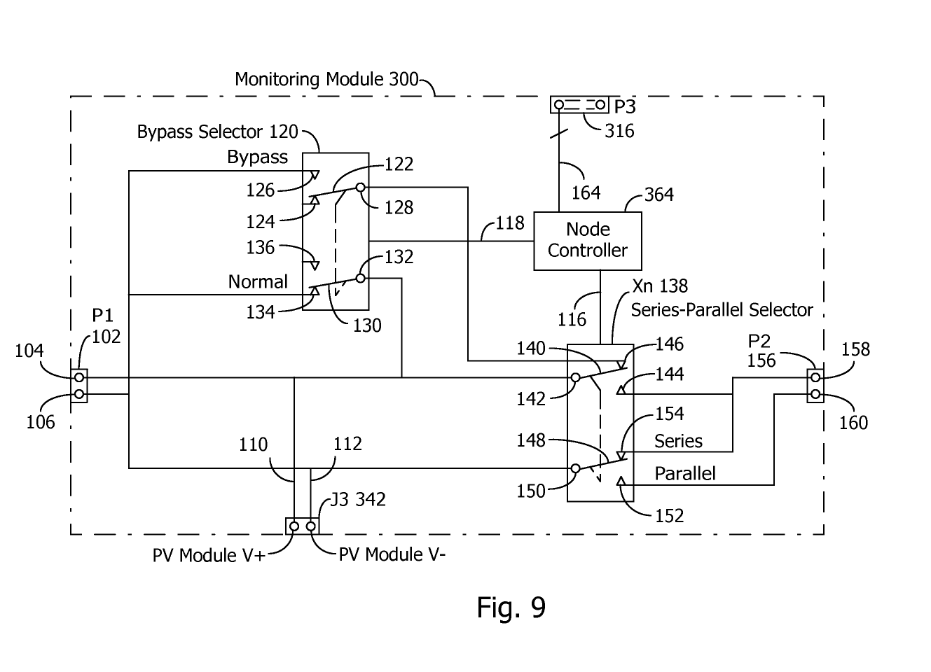

An example of an intelligent node in accord with an embodiment of the invention is shown in FIG. 1. An apparatus embodiment of the invention 100 comprises an intelligent node 366 having a monitoring module 300 for controlling electrical connections to other intelligent nodes in a PV array. Connections between two or more intelligent nodes are made through connectors P1 102 and P2 156. Unless otherwise stated, “connected” will refer hereinafter to electrical connection between two components. The monitoring module 300 optionally includes measuring and status reporting capabilities. The monitoring module 300 includes a node controller 364 connected to a series-parallel (S-P) selector 138 by an S-P control line 116. The node controller 364 is also connected to a bypass selector 120 by a bypass control line 118. Operation of the S-P and bypass selectors will be explained in more detail in relation to FIG. 9.

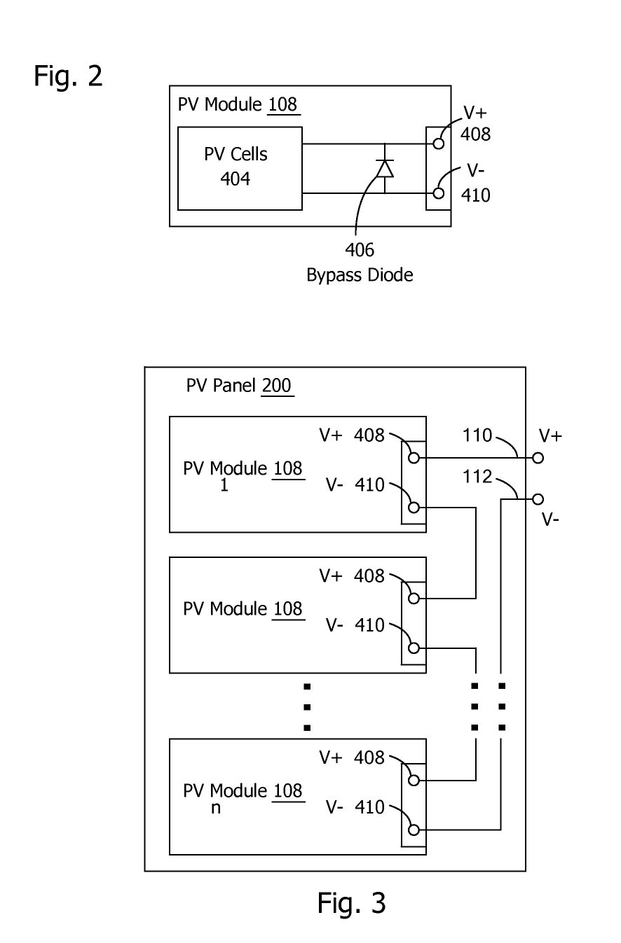

The S-P selector 138 and bypass selector 120 in the example of FIG. 1 receive current and voltage output from a PV panel 200, or from a group of PV panels, on a V+ line 110 and a V− line 112. The bypass selector 120 operates to selectively include or exclude current and voltage from the PV panel 200 from current and voltage present at connectors P1 102 and P2 156. An example of a PV panel suitable for use in an intelligent node is shown in FIG. 3, and an example of a PV module which may be used in the PV panel of FIG. 3 is shown in FIG. 2. More than one PV panel may optionally be connected to a monitoring module in an intelligent node by connecting at least two PV panels in a series electrical circuit comparable to the series electrical circuit shown in the example of FIG. 3 for connections between PV modules in one PV panel.

The PV module 108 of FIG. 2 includes PV cells 404 for converting light to electrical energy. The PV module 108 may include a plurality of PV cells 404 connected to one another in a series electrical circuit. Groups of serially-connected PV cells 404 may further be connected to one another in a parallel electrical circuit. A bypass diode 404 may be included, with the diode's cathode connected to the PV module V+ output 408 and the diode's anode connected to the V− output 410. The PV cells 404 may be electrically modeled as a diode connected to the V+ and V− outputs of the PV module. Bypass diodes may optionally be connected across V+ and V− outside the PV module 108. When several PV modules are connected in a series electrical circuit, for example as shown in FIG. 3, the bypass diode 404 may cause the polarity of the output connections (408, 410) to reverse when one or more of the PV modules is partially shadowed, when one or more of the modules develops a hot spot, or when a PV panel underperforms for other reasons. A shadowed or otherwise underperforming PV module decreases the output voltage, current, and power from the module's PV panel, which may in turn decrease output power from the entire PV array as previously stated.

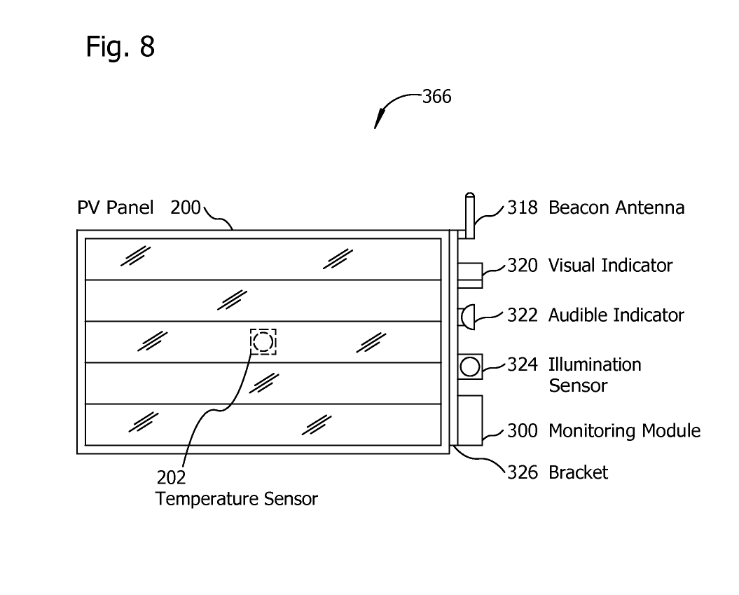

The monitoring module 300 of FIG. 1 may optionally be provided in an enclosure that is mechanically attached to a PV panel 200 as suggested in the example of an intelligent node 366 in FIG. 8. Direct attachment of the monitoring module 300 to the PV panel 300 may expose the monitoring module to high temperatures, high voltages, and electrical noise, so the monitoring module 300 may alternatively be provided in a case or enclosure that may be electrically connected to but mechanically separate from a PV panel 200. A monitoring module 300 provided as a separate enclosure also permits the monitoring module to be positioned in a location that is more easily accessible for service, repair, or replacement than the PV panels may be, for example by positioning the monitoring module close to the ground when PV panels are on an elevated structure.

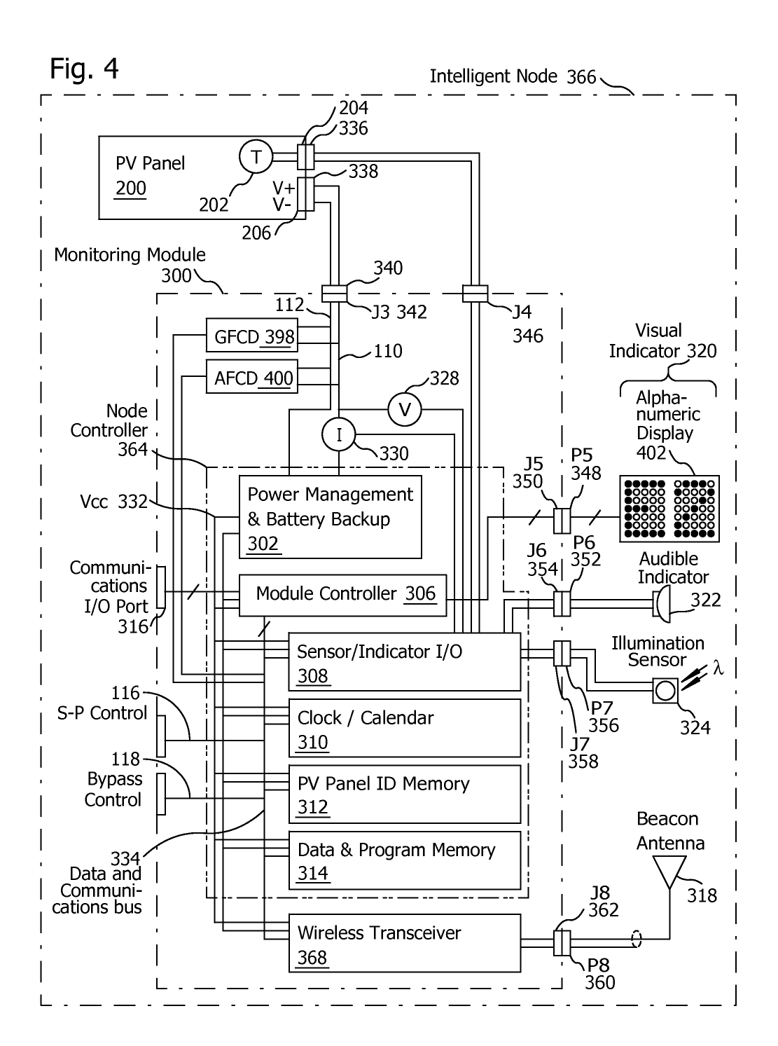

An example of an embodiment of an intelligent node is shown in FIG. 4. FIG. 4 represents a simplified block diagram of an intelligent node 366 including a monitoring module 300 electrically connected to an optional PV panel 200. The monitoring module 300 measures parameter values related to the status and performance of the PV panel 200 and optionally outputs electrical signals, visual signals, and sound signals to assist operating and maintenance personnel in identifying and locating a particular intelligent node from which reported values originated. A combination of a module controller 306, an optional power management and battery backup module 302, an optional sensor input module 308, a PV panel identification (ID) memory 312, a data and program memory 314, and a data and communications bus 334 may optionally be provided as a node controller 364 in the monitoring module 300. In some embodiments of an intelligent node, a sensor input module may be combined with an indicator output module to form a combined sensor and indicator I/O module.

The example of a monitoring module 300 in FIG. 4 includes a module controller 306 for monitoring parameters from the PV panel 200 and comparing measured parameter values against saved values to determine if the PV panel is malfunctioning or operating inefficiently. The module controller 306 sends and receives digital and optionally analog signals over a plurality of electrical connections comprising a data and communications bus 334. In some embodiments of a monitoring module, analog signals are converted to digital signals and digital signals are converted to analog signals by sensor input module 308. Alternatively, some signal conversion is accomplished within the module controller 306. The module controller 306 is adapted for communicating parameter values with an external system such as a monitoring and control system or a portable data collection system and for outputting signals for identification of the PV panel being monitored by the monitoring module 300. Electrical signals are selectively exchanged between the module controller 306 in the monitoring module 300 and an external system, for example another intelligent node or a supervisory control system, through a communications I/O port 316.

I/O port 316 represents an example of a first redundant means of communication for exchanging signals representative of data and commands between module controllers in intelligent nodes in a PV array and between a module controller in an intelligent node and an external supervisory control system. Redundant means of communication improve the reliability and availability of communications between intelligent nodes by providing for alternative communications pathways between intelligent nodes and between an intelligent node and an external system. Redundant means of communication may improve the overall reliability of a photovoltaic. Embodiments of the invention may alternatively send, receive, or send and receive the same data and commands one more than one redundant means of communication simultaneously, associate sending data and commands with one means of communication and receiving with the other, or send and receive data over one means of communication and commands over the other.

The I/O port 316 is adapted for sending and receiving signals representative of data and commands over a physical transmission medium such as a wired network using coaxial cables, twisted-pair interconnections, or other forms of interconnecting electrical cables, or optical communications over an optical fiber connection. Signals representative of data and commands may combine representations of data values and representations of commands into one signal or may segregate data and commands from one another. Data and commands may be represented as, for example but not limited to, electrical signals carried on an electrical conductor, radio signals, optical signals, analog signals, or digital signals. A wireless transceiver 368 represents an example of a second redundant means of communication. The wireless transceiver 368 is adapted for sending and receiving data and commands by exchange of radio frequency or optical signals between a transmitter and a receiver without an interconnecting physical transmission medium such as a cable, fiber optic, or wire between the transmitting and receiving systems. The monitoring module 300 may optionally operate autonomously or may measure, save, and report parameter values after receiving commands from an external system.

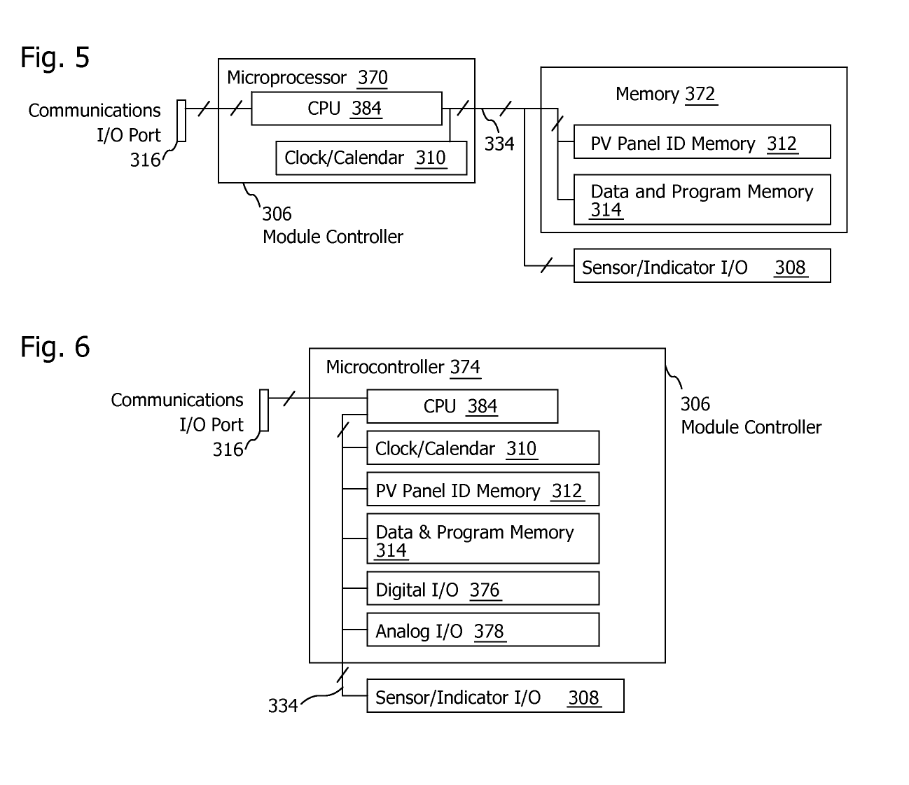

A module controller 306 may alternatively be implemented using discrete logic, a microprocessor, or a microcontroller, or as a customizable logic device such as an application specific integrated circuit (ASIC), a programmable logic device (PLD), a gate array, or a combination of these devices, and optionally includes a combination of digital and analog circuits. An example of a module controller 306 having a microprocessor is shown in FIG. 5. In FIG. 5, a module controller 306 comprises a microprocessor 370 having a central processing unit (CPU) 384 and a clock/calendar circuit 310. The CPU 384 sends and receives data and commands through a plurality of lines connected to the communications I/O port 316 on the monitoring module. The CPU 384 obtains time and date information from the clock/calendar 310, which may alternatively be implemented as a circuit in the microprocessor 370, as a peripheral electrical circuit, for example a peripheral integrated circuit, or as software executing on the CPU 384. The microprocessor 370 communicates with the sensor/indicator I/O circuit module 308 and one or more memory devices 372 over a plurality of lines comprising the data and communications bus 334. The memory device may optionally include a PV panel ID memory 312 and a data and program memory 314. Alternately, the PV panel ID memory 312 and the data and program memory 314 may be located in separate memory devices 372.

An example of a module controller 306 having a microcontroller is shown in FIG. 6. In FIG. 6, a module controller 306 comprises a microcontroller 374 having a CPU 384, a clock/calendar 310, a PV panel ID memory 312, a data and program memory 314, digital I/O 376 for exchanging digital signals with the sensor/indicator I/O circuit module 308 over the data and communications bus 334, and analog I/O 378 for exchanging analog signals with the sensor/indicator I/O circuit module 308. Optionally, an external memory device may be connected to the microcontroller 374 to increase memory capacity, for example by connecting a memory device 372 as shown in the example of FIG. 5.

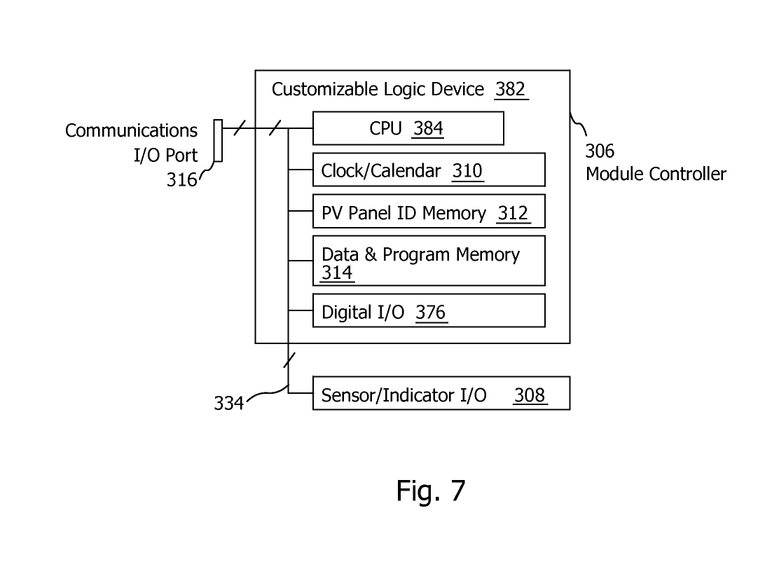

An example of a module controller 306 implemented as a customizable logic device is shown in FIG. 7. In the example of FIG. 7, the customizable logic device 382 includes a CPU 384 electrically connected to a data and communications bus 334, a clock/calendar 310, a PV panel ID memory 312, a data and program memory 314, and digital I/O circuitry 376. Analog I/O functions, for example an analog to digital converter, a digital to analog converter, a high-current output driver, and a high-voltage output driver, may optionally be part of the sensor circuit module 308. In other embodiments, some or all of these analog functions are included in the customizable logic device.

As shown in FIG. 4, the module controller 306 is electrically connected to a communications input/output (I/O) port 316. Signals representative of PV panel parameter values may optionally be output by the module controller 306 on the communications I/O port 316. Signals representative of commands to be performed by the module controller 306 may optionally be received from an external monitoring and control system on the communications I/O port 316. The module controller may receive commands or data from other intelligent nodes on the communications I/O port 316. Examples of commands and data include, but are not limited to, output of an identification code for the PV panel, output of time- and date-stamped parameter values for the PV panel, and error codes related to PV panel status. Data and commands exchanged between the monitoring module 300 and an external monitoring and control system via the communications I/O port 316 may pass over an external communications system, for example a communications system using electrical conductors, fiber optics, or power line communications (PLC).

The data and program memory 314 is adapted for storage and retrieval by the module controller 306 of commands received through the communications I/O port 316 and digital data values output from the sensor/indicator I/O circuit module 308, the PV panel ID memory 312, and the clock/calendar 310.

The module controller may optionally perform data logging to create records of PV array performance under different conditions of air temperature, solar illumination, partial shading of the PV array, array output for different S-P configurations, and so on. Time and data values may optionally be obtained from the clock/calendar circuit 310 by the module controller 306 of FIGS. 1-5. The module controller 306 may associate time and date values with one or more measured parameter values and save the time, date, and parameter values in the data and program memory 314 to form a historical log of PV panel performance. A historical log may optionally include a time and date at which the module controller 310 detects a parameter value from the PV panel 200 that is outside a range of values retrieved from the data and program memory 314. Limiting values related to a PV parameter range may optionally be received by the monitoring module 300 through the communications I/O port 316 and saved in the data and program memory 314. Limiting values for parameter ranges may optionally be modified by the module controller 306 in response to, for example, measured values of temperature or incident illumination.

When a measured parameter crosses a threshold defined by a limiting value, the monitoring module may report the condition to an external monitoring system. The external monitoring system may direct the PV array to switch to an S-P configuration retrieved from the monitoring system's storage subsystem, the monitoring system may seek improved PV array output by switching the array into many different S-P configurations, or the external monitoring system may direct the intelligent nodes in the PV array to autonomously search for a new S-P configuration that provides improved output power from the array.

The PV panel ID memory 312 in FIGS. 1-5 optionally retains an identification code assigned to each PV panel 200 in a PV array. The identification code may be saved in the monitoring module 300 at the time the monitoring module 300 is installed on a PV panel. Alternatively, an identification code may be received from an external system through the communications I/O port 316 and stored in the PV panel ID memory 312 by the module controller 306. In some embodiments, the PV panel ID memory is nonvolatile memory which may optionally be reprogrammable or may alternately be programmable once. In other embodiments, an identification code is retained in the PV panel ID memory 312 as long as the memory 312 receives power from a PV panel 200 or from a battery in the monitoring module 300.

The module controller 306 may exchange signals with alarm indicators and sensors through a sensor/indicator I/O circuit module 308. In some embodiments, the sensor/indicator I/O circuit modifies output signals from the module controller 306 so the signals have sufficient voltage and current to drive a visual indicator 320. In some embodiments of an intelligent node, inputs from sensors and outputs to indicators are partitioned into different modules. Other signals from the module controller 306 are modified so the signals are able to drive an audible indicator 322. Sensor output signals related to PV panel parameters are also conditioned by the sensor/indicator I/O circuit before being input to the module controller 306. For example, an optional illumination sensor 324 measures an amount of light incident upon the solar panel 200. The signal from the illumination sensor 324 is converted to a digital value for input to the module controller 306 and is saved by the module controller 306 in the data and programming memory 314. Alternately, an output signal from the illumination sensor 324 is converted to a corresponding digital value within the module controller 306. Electrical signals from the illumination sensor 324 are coupled into the sensor/indicator I/O circuit module 308 through an optional cable connector P7 356 and through a corresponding optional connector J7 358 on the monitoring module 300.

Output voltages V+ and V− from the PV panel 200 are output on an electrical connector J2 206, as shown in FIG. 4. Cable connector P2 338 connects to J2 206 and carries voltages V+ and V− to cable connector P3 340, which attaches to power input connector J3 342 on the monitoring module 300. Alternatively, electrical connections to and from the monitoring module may be made with point-to-point wiring instead of with electrical connectors, for example point-to-point wiring electrically connected to terminal strips. A value of PV panel 200 output current is measured by an optional current sensor 330 in series with a power connection between J3 342 and a Power Management and Battery Backup circuit 302. An output signal from the current sensor 330 is input to the sensor/indicator I/O circuit module 308, converted to a form suitable for input to the module controller 306, and a corresponding numerical value of PV panel output current is selectively stored in the data and program memory 314. Similarly, a value of PV panel 200 output voltage is measured by a voltage sensor 328 electrically connected to the power input connector J3 342 and sensor/indicator I/O circuit module 308, and a PV panel output voltage value is selectively saved in the data and program memory 314. The module controller 306 may then compare measured values of current and voltage from the PV panel 200 against, for example previously saved values, or against a range of values related to an amount of illumination measured by the illumination sensor 324 to determine if the PV panel is operating efficiently or if it is producing a smaller amount of output power than expected.

A PV panel 200 may optionally include one or more temperature sensors 202. Signals related to temperatures on the PV panel 200 are output from a connector 204 on the PV panel 200, coupled to cable connector 336 and then to connector J4 346 on the monitoring module 300. Output signals from the temperature sensor 202 pass through lines from connector J4 346 to inputs to the sensor/indicator I/O circuit module 308. Values for measured temperatures on the PV panel 200 are selectively saved in the data and program memory 314 for subsequent comparison by the module controller 306 against a range of operating temperatures for normal operation of the PV panel. A measured temperature may also be used by the module controller 306 to modify expected values of other parameters, for example a value of output current expected at a particular temperature. A measured temperature outside a range of operating temperatures is detected by the module controller 306, which may send a signal representing an alarm condition to the communications I/O port 316 and the sensor/indicator I/O circuit module 308.

A signal representing an alarm condition may cause activation of one or more alarm indicators such as a visual indicator 320 or an audible indicator 322. In some embodiments, for example the embodiment shown in FIG. 4, the visual indicator 320 comprises one or more incandescent bulbs or light-emitting diodes (LEDs) capable of being collectively turned on and off in response to a signal output from the sensor/indicator input/output circuit 308 under the control of the module controller 306. In other embodiments, the visual indicator 320 comprises an alphanumeric display adapted to show an error code, a panel identification number, or other selected alphanumeric values. An example of a visual indicator 320 comprising an alphanumeric display 402 is shown in FIG. 2. In the example of FIG. 4, the alphanumeric display 402 displays an error code “E2”, although one will appreciate that other letters and numbers could also be displayed. In the example of FIG. 4, the alphanumeric display 402 receives input signals representative of data to be displayed from the module controller 306. In other embodiments, the alphanumeric display receives input signals from the sensor/indicator I/O circuit module 308. The alphanumeric display 402 in FIG. 4 may alternatively be implemented as an LED display, a vacuum fluorescent display, a liquid crystal display, an electromechanical display, or other types of display capable of showing characters which may be read in daylight or at night by service personnel standing several yards (meters) away from the PV panel 200. Although the example of FIG. 4 shows an alphanumeric display for two characters, a display for showing more than two characters may be used.

Signals from the sensor/indicator I/O circuit module 308 to the visual indicator 320 are optionally coupled through connector J5 350 on the monitoring module 300 and cable connector P5 348 electrically connected to the visual indicator 320, as shown in FIG. 4. Signals from the sensor/indicator I/O circuit module 308 to the audible indicator 322 are optionally coupled through connector J6 354 on the monitoring module 300 and cable connector J6 352 electrically connected to the audible indicator 322.

The visual indicator 320 and the audible indicator 322 are provided to assist service personnel in locating a PV panel having an out of range temperature condition as determined by the module controller 320. Furthermore, the module controller 306 may optionally output an alarm signal for a current sensor 330 output signal or a voltage sensor 328 output signal outside a range expected for a measured amount of incident illumination. For example, a PV panel exposed to sunlight but having no output current may cause an alarm signal to be output by the module controller 306. The module controller may optionally suppress the output of some alarm signals when the illumination sensor senses that the panel is receiving too little illumination to output usable electric power. Sounds produced by the audible indicator 322 and lights emitted from the visual indicator 320 may optionally be output in selected on-off patterns for conveying information to a person seeing or hearing the alarm indicator. Data related to selected patterns and associated error conditions are stored in the data and program memory 314 and retrieved by the module controller 306.

A monitoring module 300 optionally includes a wireless transceiver 368 electrically connected to the module controller 306 over the data and communications bus 334 as shown in FIG. 4. The wireless transmitter 304 selectively transmits and receives radio frequency signals related to data from the module controller 306 and data and program memory 314 over a beacon antenna 318. Electrical signals between the beacon antenna 318 and the wireless transmitter 304 pass through an optional cable connector P8 360 and a corresponding connector J8 362 on the monitoring module 300. The wireless transceiver 368 is representative of a second redundant means of communication for input and output of data and commands related to the operation of the module controller 306, monitoring module 300, intelligent node 366, and PV panel 200.

Data sent from the module controller 306 to the wireless transmitter 304, or alternately to the transceiver 368, optionally includes, but is not limited to, a PV panel identification code, a time value, a data value, values for PV panel temperature, output current, and output voltage, a value for incident illumination, positions of bypass selector 120 and S-P selector 138, and data related to operational status of the monitoring module 300, for example, but not limited to, charge status of a battery in the power management and battery backup circuit 302. One will appreciate that many other data items related to PV panel condition may optionally be sent by the module controller 306 to the wireless transmitter 304 for radio transmission to an external system. In some embodiments, the wireless transmitter 304 or the transceiver 368 conforms to a communication protocol for relatively long range communications. In other embodiments, the wireless transmitter 304 or the transceiver 368 conforms to a communications protocol for relatively short range communications, such as Bluetooth (IEEE 802.11) or similar standards for sending information to portable devices separated by a few meters from the monitoring module. Such a portable device may be carried by service personnel or carried in a vehicle for rapidly scanning output transmissions from a large number PV panels in a PV array. Any one or more of the previously described data items may be exchanged bidirectionally between the module controller 306 and an external system, for example another intelligent node or an external supervisory and control system, through either one or both of the redundant means of communication.

If one of the redundant means of communication is not available for communication, for example because the means of communication is not operable or is busy, the module controller 306 may autonomously select the other redundant means of communication to data and commands with other systems. Alternatively, an external system may command the module controller to select a specific one of the redundant means of communication for conducting communications with the external system or with other intelligent nodes. Some intelligent nodes in a PV array may use one of the redundant means of communication while other intelligent nodes are using a different one of the redundant means of communication.

Referring again to FIG. 4, power to operate the monitoring module 300, optional sensors, and optional alarm indicators is supplied by the PV panel 200. Output current and output voltage from the PV panel 200 are input to the power management and battery backup circuit 302. The power management and battery backup circuit 302 distributes the current and voltage received from the PV panel 200 on a power bus Vcc 332 to other parts of the PV panel monitoring apparatus 100. Optionally, the power management and battery backup circuit 302 outputs a voltage Vcc having a different value than the value of voltage output from the PV panel 200. The power management and battery backup circuit 302 includes a backup battery and circuitry for charging the battery so that the monitoring module 300 may continue to operate when the PV panel is not producing sufficient output power, for example at night or when a shadow falls across the PV panel.

As shown in the example of FIG. 1, the intelligent node 366 includes a monitoring module 300, at least one PV Panel 200, an S-P selector 138, and a bypass selector 120. In some embodiments of a monitoring module 300, the S-P selector 138 and bypass selector 120 are included in a common enclosure or case with other parts of the monitoring module 300. In alternative embodiments of a monitoring module 300, the monitoring module 300 includes a series-parallel control port 116 and a bypass control port 118, each connected to the data and communications bus 334 and in data communication with the module controller 306, with either one or both of the series-parallel switch and bypass selector mounted externally to the monitoring module 300 and connected to the monitoring module by cable assemblies.

Some embodiments of a monitoring module 300 include circuits for detecting a ground fault in a photovoltaic panel or in cables connecting a PV panel or monitoring module to other parts of a PV array. A Ground Fault Circuit Detector (GFCD) 398 in FIG. 4 is electrically connected in parallel with V+ and V− lines from the output of the PV panel 200 to the inputs of the power management and battery backup circuit 302. In order to reduce the risk of fire from an electrical short circuit or an electrical arc resulting from breakdown in electrically insulating materials in the PV panel 200, monitoring module 300, or electrical connections between these components, some embodiments include an arc fault circuit detector (AFCD) 400, also electrically connected in parallel with V+ and V− lines from the output of the PV panel 200 to the inputs of the power management and battery backup circuit 302. An output from the GFCD 398 and an output from the AFCD 400 are electrically connected to the data and communications bus 334. Alternately, outputs from the GFCD 398 and AFCD 400 are electrically connected directly to inputs on the module controller 306, for example interrupt inputs. Upon receiving a signal from the GFCD 398 or the AFCD 400, the module controller 306 may selectively shut down parts of the monitoring module 300, cause the PV panel 200 to be electrically bypassed or electrically disconnected from the PV array in which the PV panel resides. The monitoring module 300 optionally outputs audible or visual alarm signals to warn service personnel about ground fault or arc fault hazards.

A front view of an example of an intelligent node 366 comprising a monitoring module mechanically attached to a PV panel is shown in FIG. 8. One or more optional temperature sensors 202 are attached to the PV panel 200 to measure PV panel operating temperatures. In the example of FIG. 8, a temperature sensor 202 is attached to a back surface of the photosensitive area of the PV panel 200. In some embodiments, a monitoring module 300, illumination sensor 324, audible indicator 322, visual indicator 320, and beacon antenna 318 are mechanically attached to a bracket 326. An illumination sensor 324 may optionally be attached to a front surface of the PV panel 200, preferably in a location which does not reduce sunlight exposure of a solar cell in the PV panel. The bracket 326 provides structural support for the monitoring module, sensors, and indicators, and further provides a standardized mechanical interface for attachment to PV panels in a PV array. Although the example of FIG. 2 shows the bracket 326 attached to a right side of the PV panel 200, alternative embodiments of the invention may have a bracket attached to one or more of the other sides of the PV panel. The bracket 326 may optionally provide mechanical support for the PV panel 200 and other components when the bracket 326 is attached to an external support structure. Other alternative embodiments have the beacon antenna 318, visual indicator 320, and other components arranged in a different order on the bracket 326. The monitoring module 300 may optionally be positioned some distance away from the PV panel 200 and not attached to the bracket 326 while electrically connected to at least one PV panel 200.

Embodiments of an intelligent node include a bypass selector and an S-P selector as described in relation to FIG. 1. An example of a node controller, bypass selector, and S-P selector is shown in FIG. 9. Switching states for the electrically controlled bypass selector 120 and the electrically controlled S-P selector Xn 138 determine how current and voltage output from the PV module 108 is combined with electrical power flowing through the first and second power connectors P1 102 and P2 156. As shown in FIG. 9, the bypass selector 120 and the S-P selector Xn 138 are preferably double-pole, double-throw (DPDT) electromechanical relays. Either one or both of the selectors (120, 138) may alternatively be replaced by a solid state relay or solid state switching devices made from discrete electronic components. Either selector (120, 138) may optionally be changed from a single DPDT electrically controlled switching device to a pair of single-pole, single-throw switching devices sharing a common control line electrically connected to the node controller 114.

Referring to FIG. 9, electric power from other intelligent nodes in a configurable PV array may optionally be connected to the intelligent node 366 on the second power connector P2 156 comprising a first terminal 158 and a second terminal 160. Voltage and current on the P2 first terminal 158 and the P2 second terminal 160 are selectively combined with voltage and current output from the PV panel 200 according to selected switching states for the bypass selector 120 and the S-P selector Xn 138. The P2 first terminal 158 is electrically connected to a parallel terminal 144 of a first S-P switch 140 in the S-P selector Xn 138. The P2 first terminal 158 is further electrically connected to a series terminal 154 of a second S-P switch 148 in the S-P selector Xn 138. The P2 second terminal 160 is electrically connected to a parallel terminal 152 of the second S-P switch 148.

A series terminal 146 of the first S-P switch 140 is electrically connected to a common terminal 128 for a first bypass switch 122 in the bypass selector 120. A common terminal 142 of the first S-P switch 140 is electrically connected to a common terminal 132 for a second bypass switch 130 in the bypass selector 120. The common terminal 142 of the first S-P switch 140 is further connected electrically to a connector P1 first terminal 104. A common terminal 150 of the second S-P switch 148 is electrically connected to a negative terminal 112 on the PV module 108, to a connector P1 second terminal 106, and to a bypass terminal 126 of the first bypass switch 122 in the bypass selector 120.

A bypass selector control line 118 carries control signals from the node controller 114 to a control input of the bypass selector 120. A first control signal from the node controller 114 on the bypass selector control line 118 sets the bypass selector 120 to a “Bypass” switching state in which output from the PV module 108 is excluded from the voltage and current on the terminals of the first power connector P1 102. A “Bypass” switching state is also referred to herein as a “B” switching state. In a Bypass switching state, output power from the PV panel 200 is excluded from current and voltage on connectors P1 102 and P2 156. A second control signal from the node controller 114 on the bypass selector control line 118 sets the bypass selector 120 to a “Normal” switching state in which output from the PV panel 200 is selectively combined with the voltage and current on the terminals of the connector P1 102 according to one of two alternate switching states for the S-P selector Xn 138. A “Normal” switching state is also referred to herein as an “N” switching state. In the example of FIG. 9, the first bypass switch 122 and the second bypass switch 130 in the bypass selector 120 are shown in the “Normal” switching state. FIG. 9 further shows the first bypass switch 122 normal terminal 124 and the second bypass switch 130 bypass terminal 136 as unterminated. Passive components may optionally be electrically connected to the unterminated terminals to reduce electrical noise coupled into the circuit.

A series-parallel selector control line 116 carries control signals from the node controller 114 to a control input of the S-P selector Xn 138. A third control signal from the node controller 114 on the series-parallel selector control line 116 sets the S-P selector Xn 138 to a “Series” switching state, also referred to herein as an “S” switching state. A fourth control signal from the node controller 114 on the series-parallel selector control line 116 sets the S-P selector Xn 138 to a “Parallel” switching state, also referred to herein as a “P” switching state. In the example of FIG. 2, the first S-P switch 140 and the second S-P switch 148 in the S-P selector Xn 138 are shown in the “Series” switching state.

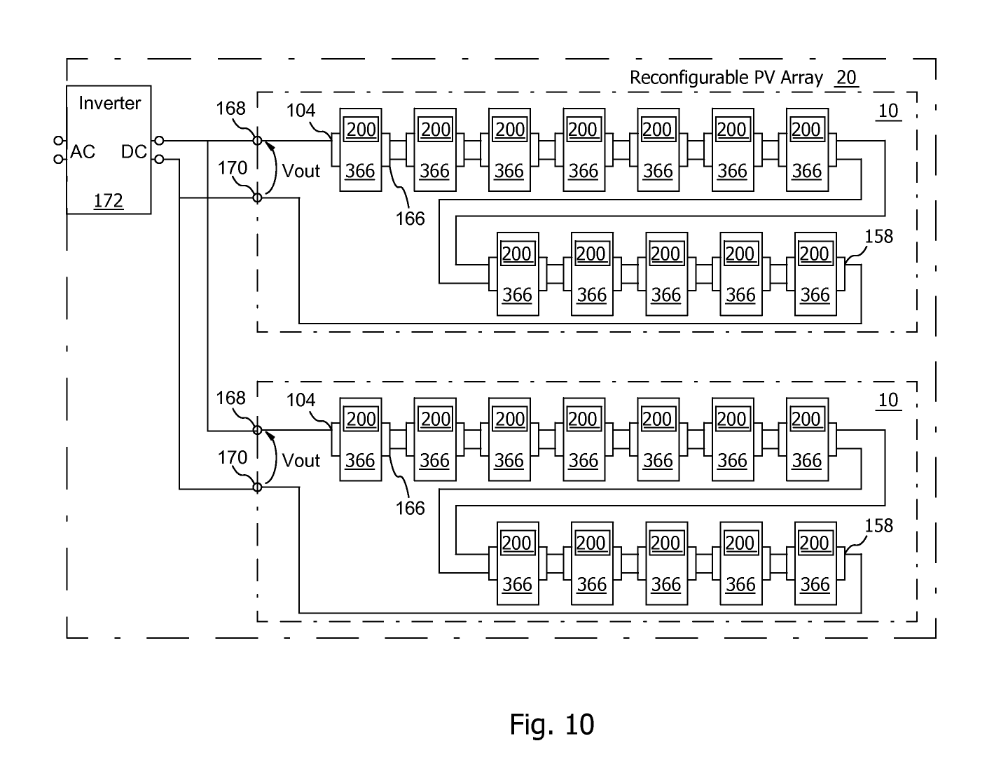

FIG. 10 shows an example of an embodiment of the invention comprising twelve intelligent nodes 366 interconnected to form a reconfigurable PV array 20. Each of the intelligent nodes 366 in FIG. 10 includes a PV panel 200 and the S-P and Bypass selectors described above. FIG. 10 shows a simplified representation of a reconfigurable array 20 having two groups 10 of interconnected intelligent nodes. The array 20 has outputs (168, 170) connected to inputs of an inverter 172 for converting DC electrical power to AC electrical power. FIG. 10 is representative of connections between intelligent nodes in PV arrays having a different number of intelligent nodes 366 in each group 10 and a different number of groups 10 in the PV array 20.

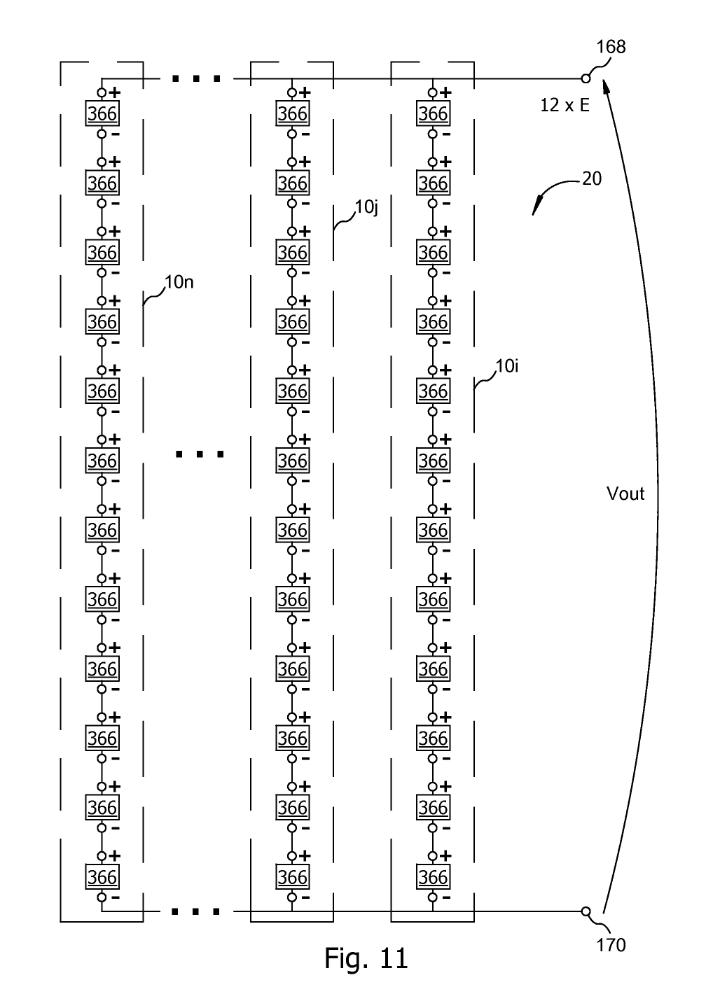

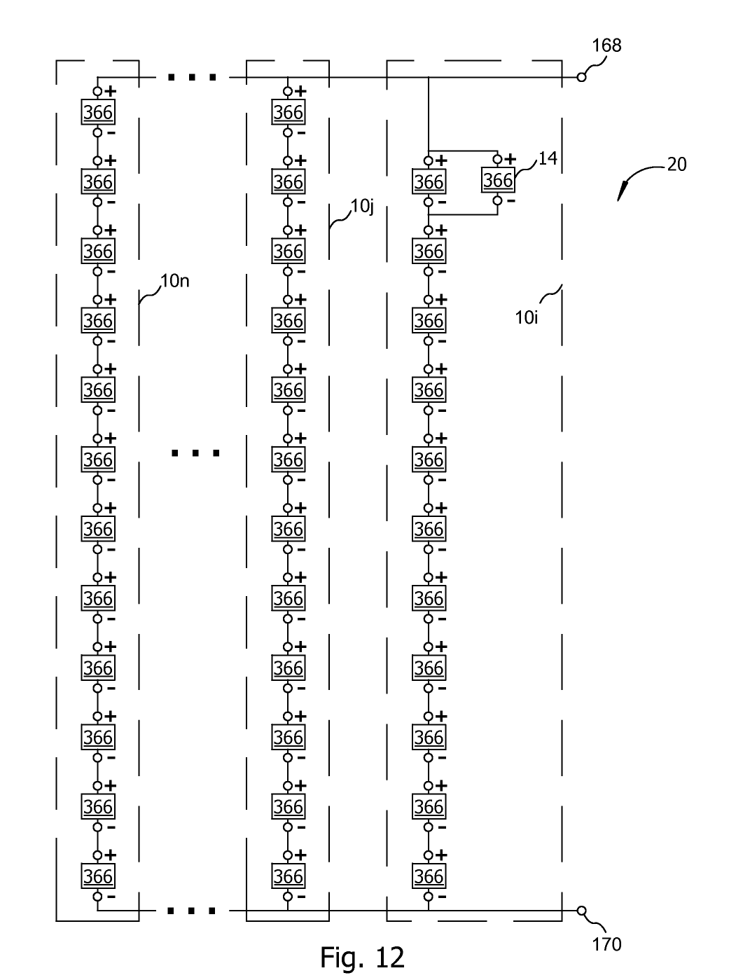

FIGS. 11-13 represent a few of the many different S-P configurations that may be made for a PV array of a given size. An S-P configuration refers to an arrangement of serial and parallel connections between intelligent nodes in an photovoltaic array. Changing at least one serial connection or at least one parallel connection between any two or more intelligent nodes in a photovoltaic array places the array in a new S-P configuration. Embodiments of the invention are capable of rapidly switching from one S-P configuration to another without connecting or disconnecting cables or wires used to make electrical connections between PV modules on a PV panel or between PV panels in a PV array. FIG. 11 represents “n” groups (10i, 10j, . . . 10n) of intelligent nodes 366 interconnected to form a PV array 20 having power outputs 168 and 170. In the example of FIG. 11, all of the intelligent nodes 366 within each group (10i, 10j, . . . 10n) are connected in a series circuit. In FIG. 12, one of the intelligent nodes (14) in group 10i has been reconfigured by the S-P selectors 138 for parallel circuit connection to its neighboring intelligent node 366. Placing intelligent node 366 (14) in a parallel circuit with one or more neighboring nodes permits electrical power from node (14) to be included in the output of the PV array 20, thereby salvaging power from the node that would otherwise have been lost. Note that connections between intelligent nodes 366 in other groups (10j, . . . 10n) have not been changed in FIG. 12 compared to FIG. 11.

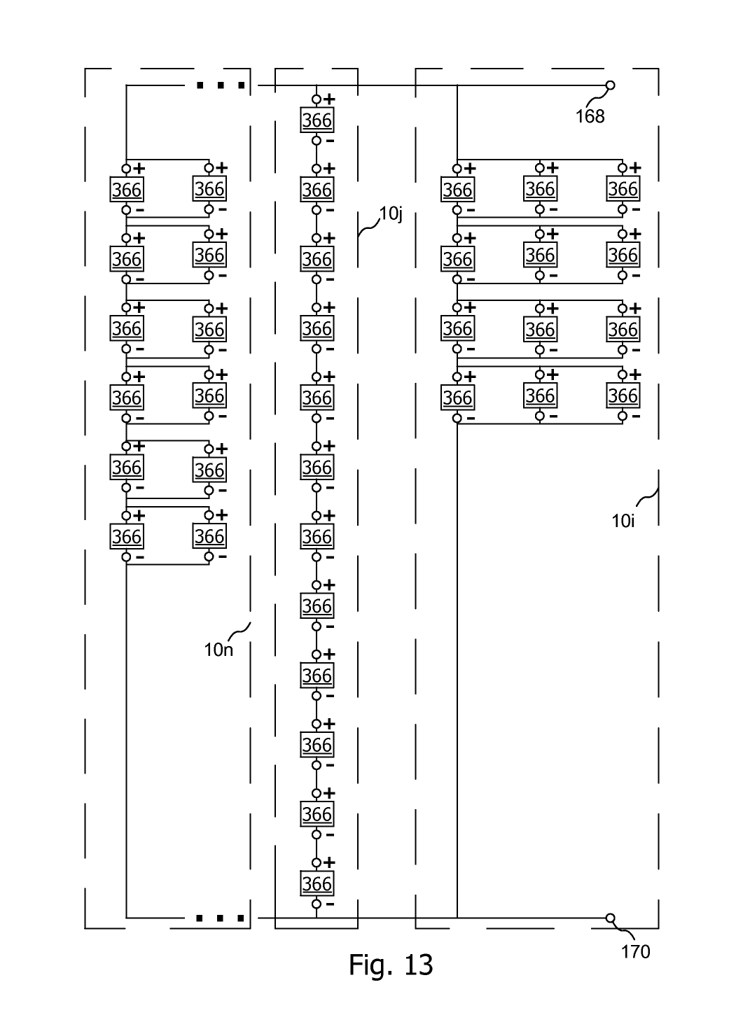

In FIG. 13, intelligent nodes 366 in group 10i have been reconfigured to a new arrangement of serial and parallel electrical connections. Group 10n has also been changed to a different configuration of connections between intelligent nodes 366. Although FIG. 13 shows group 10i with four serially-connected subsets of three parallel-connected nodes, each subset could in practice have a different number of intelligent nodes 366. Furthermore, changing series-parallel connections in one group, for example group 10i, may be done independently of any configuration imposed on other groups, for example groups 10j and 10n in FIG. 13. It will be appreciated that even for the relatively small PV array illustrated in the examples of FIGS. 11-13, it is not practical to include in the figures every possible permutation of serial and parallel connections between intelligent nodes 366, which range from the configuration of FIG. 12 to a configuration (not illustrated) in which all intelligent nodes are in a parallel electrical circuit, with array output voltage, current, and power adjustable between corresponding limits by suitable selection of serial and parallel connections between intelligent nodes.

FIGS. 10-13 suggest the flexibility that may be achieved in reconfiguring serial and parallel electrical connections between intelligent nodes in a PV array in accord with an embodiment of the invention. An intelligent node may be used to extract a maximum amount of output power from a PV array by selectively reconfiguring the array, measuring the output power for each array configuration, identifying the maximum power achieved and its corresponding array configuration, then returning the PV array to the configuration corresponding to maximum power output. Optimization can be accomplished without resorting to mathematical models, for example models of PV panel characteristics or PV array performance. An optimized PV array will salvage energy from shaded or otherwise underperforming PV panels that would have been wasted in prior art systems. Optimization of output power, that is, finding a maximum amount of output power corresponding to actual PV array operating conditions, can be performed even when a cause for underperformance is unknown and mathematical models may therefore be difficult to apply, or when a PV array is simultaneously subjected to more than one cause for underperformance.

Because of the speed with which embodiments of the invention can switch from one array configuration to another, it can be reasonable to test every possible array configuration in a relatively short time period, even for large PV arrays. For example, an embodiment of the invention is capable of switching several hundred PV panels to a new S-P configuration and measuring a new PV array output power value in about one second. Very large arrays may take no more than a few seconds per S-P configuration tested. In some cases, for example when all the underperforming PV panels are detected to be in a common group (see a common group 10i in FIGS. 11-13), it may be necessary to reconfigure only the affected group to find a new maximum output power for the PV array. As operational experience is gained with a particular installation of a reconfigurable PV array, a supervisory control and monitoring system can store which optimized S-P configurations are best suited to previously encountered situations and quickly restore the PV array to the previously determined optimum configuration when the corresponding situation is detected again.

Operator experience and conventional mathematical modeling methods may be used to eliminate some combinations of series-parallel connections from the array configurations to be tested. A mathematical model may be used to predict a starting S-P configuration to be evaluated. However, even when such models are available, they may contain inaccurate or dated information about PV panels, weather conditions, panel cleanliness, panel aging effects, array impedance, load impedance, and other operational parameters that affect power output. Embodiments of the invention permit PV array output to be maximized according to actual field conditions at the time an optimization is conducted.

A method embodiment of the invention adaptively selects a combination of serial and parallel electrical connections between intelligent nodes in a reconfigurable PV array to produce the maximum PV array output power under measured or predicted electrical load conditions, measured, predicted, or reported environmental conditions, measured, predicted, or reported power output or status of individual PV modules and PV panels, and other operational parameters in effect at the time the method is performed. An example of a method embodiment of the invention comprises:

connecting a plurality of PV panels in a PV array in an initial series-parallel (S-P) configuration corresponding to an initial arrangement of serial and parallel electrical connections between the PV panels, and calculating an initial value of PV array output power for the initial S-P configuration;

detecting a decrease in output power from the PV array in comparison to the initial value of power output from the PV array;

instructing each intelligent node to place the PV array in a new S-P configuration and measuring the output voltage and current for the new S-P configuration;

calculating the output power corresponding to the new S-P configuration;

saving S-P configuration data including a value corresponding to the switching state of each bypass switch and S-P switch in the array and the output power corresponding to the S-P configuration;

reconfiguring the PV array into a plurality of new S-P combinations, and for each new S-P configuration, storing PV array output power and S-P configuration data, until all members of a selected set of S-P configurations have been implemented and measured and their corresponding output power values saved;

selecting the maximum saved value of PV array output power and its associated S-P configuration data; and

setting the PV array to the S-P configuration corresponding to the selected maximum value of PV array output power by setting the S-P selector on each PV panel according to the retrieved value representing the switching state.

The following steps are optional:

detecting a fault condition in a PV panel or in the PV array that would lead to a decrease in PV array output power and changing the array configuration in anticipation of a power decrease that may not yet have occurred;

placing the PV array in a new S-P configuration corresponding to a new maximum value of PV array output power upon detection of a ground fault in the PV array;

placing the PV array in a new S-P configuration corresponding to a new maximum value of PV array output power upon detection of an arc fault in the PV array;

placing the PV array in a new S-P configuration corresponding to a new maximum value of PV array output power when a shadow falls on at least one PV panel in the PV array;

detecting a polarity reversal in the output from at least one PV module and initiating a search for a new maximum power configuration of the PV array;

preventing a search for a new S-P configuration for decreases in PV array output power that persist for less than a selected duration of time;

preventing a search for a new S-P configuration for decreases in PV array output power that are less than a selected threshold value;

preventing the PV array from being placed into an S-P configuration having a predicted value for PV array output power that is less than a previously saved value of PV array output power;

changing serial and parallel electrical connections between PV panels in a subset of the PV array that includes fewer than all panels in the PV array;

autonomously selecting one of two redundant means of communication by a module controller connected to a PV panel when the other of the two redundant means of communication is not available for communication;

placing the PV array in an S-P configuration associated with a recurring event, for example a shadow that passes across part of the PV array at a predictable time each day or at certain times of year, or a preventive maintenance schedule that disconnects selected panels from the array for cleaning or repair;

initializing the array configuration to a combination of serial and parallel electrical connections predicted by a mathematical model, then reconfiguring and measuring PV array performance beginning from that initial configuration; and

eliminating from a set of S-P configurations to be tested any configurations which a mathematical model predicts will be unproductive.

Unless expressly stated otherwise herein, ordinary terms have their corresponding ordinary meanings within the respective contexts of their presentations, and ordinary terms of art have their corresponding regular meanings.

What is claimed is:

1. A monitoring module for a photovoltaic panel, comprising:
a module controller;
a serial-parallel selector control output electrically connected to said module controller;
a bypass selector control output electrically connected to said module controller;
a first of two redundant means of communication electrically connected to said module controller;
a second of two redundant means of communication electrically connected to said module controller;
a sensor input module in data communication with said module controller;
a power management circuit adapted to receive input power from at least one photovoltaic panel and having an output for providing electrical power to said module controller;
wherein said module controller selects one of said two redundant means of communication when the other of said two redundant means of communication is not available for communication, said module controller is adapted to control a series-parallel switching state of a serial-parallel selector connected to said serial-parallel selector control output, and said module controller is adapted to control a bypass switching state of a bypass selector connected to said bypass selector control output.

2. The monitoring module of claim 1, wherein said first of two redundant means of communication comprises a communications input and output port connected to said module controller, wherein said communications input and output port is adapted for exchange of signals representative of data and commands over a physical transmission medium.

3. The monitoring module of claim 1, wherein said second of two redundant means of communication comprises a wireless transceiver connected for data communication with said module controller.

4. The monitoring module of claim 1, further comprising:
an indicator output circuit; and
a visual indicator electrically connected to said indicator output circuit.

5. The monitoring module of claim 1, further comprising an illumination sensor for measuring an amount of light incident upon a photovoltaic panel.

6. The monitoring module of claim 1, further comprising a voltage sensor electrically connected to said sensor input module, wherein said voltage sensor measures an amount of output voltage from a photovoltaic panel.

7. The monitoring module of claim 1, further comprising a current sensor electrically connected to said sensor input module, wherein said current sensor measures an amount of output current from a photovoltaic panel.

8. The monitoring module of claim 1, further comprising a ground fault circuit detector for detecting a ground fault in a photovoltaic panel.

9. The monitoring module of claim 1, further comprising an arc fault circuit detector for detecting insulation breakdown in a photovoltaic panel.

10. A method for selecting a combination of serial and parallel electrical connections between photovoltaic (PV) panels in a PV array, comprising:
connecting a plurality of PV panels in a PV array in an initial series-parallel (S-P) configuration corresponding to an initial arrangement of serial and parallel electrical connections between the PV panels, and calculating an initial value of PV array output power for the initial S-P configuration;
detecting a change in an amount of PV array output power in comparison to the initial value of PV array output power;
reconfiguring the PV array into a plurality of new S-P configurations, and for each new S-P configuration, storing a value of PV array output power and a value representing a switching state for an S-P selector on each PV panel in the PV array;
selecting the maximum value of PV array output power from the stored values of PV array output power;
retrieving the value representing the switching state for an S-P selector on each PV panel in the PV array corresponding to the maximum value of PV array output power;
setting the PV array to the S-P configuration corresponding to the selected maximum value of PV array output power by setting the S-P selector on each PV panel according to the retrieved value representing the switching state.

11. The method of claim 10, further comprising placing the PV array in a new S-P configuration corresponding to a new maximum value of PV array output power upon detection of a ground fault in the PV array.

12. The method of claim 10, further comprising placing the PV array in a new S-P configuration corresponding to a new maximum value of PV array output power upon detection of an arc fault in the PV array.

13. The method of claim 10, further comprising placing the PV array in a new S-P configuration corresponding to a new maximum value of PV array output power when a shadow falls on at least one PV panel in the PV array.

14. The method of claim 10, further comprising placing the PV array in a new S-P configuration corresponding to a new maximum value of PV array output power when a polarity reversal is detected in an output voltage from a PV panel.

15. The method of claim 10, further comprising preventing a search for a new S-P configuration when a decrease in an amount of PV array output power persists for less than a selected duration of time.

16. The method of claim 10, further comprising preventing the PV array from being placed into an S-P configuration having a predicted value for PV array output power that is less than a previously saved value of PV array output power.

17. The method of claim 10, further comprising preventing the PV array from being placed into a new S-P configuration for a magnitude of change in a value of PV array output power that is less than a selected threshold value.

18. The method of claim 10, further comprising changing serial and parallel electrical connections between PV panels in a subset of the PV array that includes fewer than all panels in the PV array.

19. The method of claim 10, further comprising a module controller connected to a PV panel autonomously selecting one of two redundant means of communication when the other of the two redundant means of communication is not available for communication.

20. The method of claim 10, further comprising placing the PV array in an S-P configuration associated with a recurring event.
